(19) United States
(12) Patent Application Publication
(10) Pub. No.: US 2015/0153384 A1
(43) Pub. Date: Jun. 4, 2015

(54) DEVICE FOR CHECKING A PROBE FOR MEASURING THE PRESSURE OF A FLOW

(71) Applicant: THALES, NEUILLY-SUR-SEINE (FR)

(72) Inventor: François ROBERT, CHANCEAUX SUR CHOISILLE (FR)

(21) Appl. No.: 14/555,932

(22) Filed: Nov. 28, 2014

(30) Foreign Application Priority Data
Nov. 29, 2013 (FR) 1302779

(51) Int. Cl. G01P 21/02; G01N 29/024; G01P 5/16

(52) U.S. Cl. CPC G01P 21/025; G01P 5/16; G01N 29/024

(57) ABSTRACT

A device is provided for checking a probe for measuring the pressure of a flow, the probe comprising: an internal volume; at least one orifice communicating with the outside of the volume; an acoustic loudspeaker, comprising an enclosure and a membrane sealing an opening of the enclosure; the opening being intended to be connected to the internal volume of the probe, so that the loudspeaker transmits an acoustic signal that is propagated through the opening into the internal volume; an acoustic receiver positioned in the enclosure of the loudspeaker that makes it possible to pick up an acoustic signal originating from outside the enclosure and passing through the membrane; and means for comparing the acoustic signal observed in the enclosure to a reference acoustic signal.

### CROSS-REFERENCE TO RELATED APPLICATION

This application claims priority to foreign French patent application No. FR 1302779, filed on Nov. 29, 2013, the disclosure of which is incorporated by reference in its entirety.

### FIELD OF THE INVENTION

The invention relates to a device for checking a probe for measuring the pressure of a flow. The invention is of particular use in the field of the pressure probes implemented in the aeronautical field.

### BACKGROUND

In effect, piloting any aircraft entails knowing its relative speed in relation to the air, that is to say to the relative wind. This speed is determined using static pressure Ps and total pressure Pt measurement probes. The total Pt and static Ps pressures provide the modulus of this speed vector.

As is known, the total pressure Pt can be measured using a so-called Pitot tube. This is a tube that is open at one of its ends and blocked at the other. The open end of the tube faces substantially into the flow. The stream of air situated upstream of the tube is progressively slowed down until it reaches an almost zero speed at the tube inlet. The slowing down of the speed of this stream of air increases its pressure. This increased pressure forms the total pressure Pt of the flow of air. The principle of such a total pressure measurement probe is recalled by FIG. 1. The probe 10 is intended to be fixed through an opening 11 produced in the skin 12 of an aircraft. The probe 10 comprises a part 13 external to the skin 12 and formed by a Pitot tube 14 formed by a strut 15. The probe 10 also comprises an internal part 16 essentially comprising an electrical connector 17 and a pneumatic connector 18. The connector 17 makes it possible to electrically connect the probe 10 to the aircraft, for example to connect heating means for the de-icing of the probe 10. The connector 18 allows for the pneumatic connection of the Pitot tube 14 to a pressure sensor or other measurement device, situated inside the skin 12 of the aircraft. The probe 10 is positioned on the skin 12 of the aircraft in such a way that the Pitot tube 14 is oriented substantially along a longitudinal axis of the aircraft, excluding the boundary layer, for the direction of flow, embodied by an arrow 19, to substantially face an inlet orifice 20 situated at a first end 21 of the Pitot tube 14. In the example represented, the Pitot tube 14 is fixed relative to the skin 12 of the aircraft. It is of course possible to mount the Pitot tube 14 on a moving strut such as, for example, a paddle that can be oriented in the axis of the flow as is, for example, described in the patent published under the number FR 2 665 539.

In practice, the flow of air can convey solid or liquid particles, such as, for example, the water from clouds, that are likely to penetrate into the Pitot tube and build up in the tube at the blocked end. To prevent such a build-up from disturbing the pressure measurement, one or more drain holes and water traps are generally provided, to avoid any risk of blocking of the ducts responsible for transmitting the total pressure to the pressure sensors situated inside the skin of the aircraft or to the instruments of the aircraft instrument panel. As represented in FIG. 2, the Pitot tube 14 thus comprises, in proximity to an end 22, a drain hole 23 that makes it possible to discharge particles likely to penetrate inside the tube 14. Still at the end 22 of the tube, an air line 24 opens into the tube 14 to form a pressure tap 40 therein where the air pressure is to be measured. The pressure tap 40 is generally constructed in such a way as to avoid the ingestion of water into the tube 14 and thus form a water trap. The line 24 is, for example, linked to a pressure sensor that is not represented in FIG. 2. The pressure sensor makes it possible to effectively measure the pressure of the air prevailing inside the tube 14 at its end 22. Apart from the drain hole or holes 23, whose sections are small compared to that of the tube 14, the tube 14 is closed at its end 22. The pressure measured at this end therefore represents the total pressure Pt of the flow of air.

The drain holes make it possible to discharge any liquids and particles that might penetrate into the tube. The slowing down of the air in the tube is therefore not complete and the total pressure measurement Pt is affected. More specifically, the greater the efforts to avoid the build-up of water or of particles of significant size, the more the total pressure measurement is affected by increasing the dimensions or the number of drain holes. Conversely, the greater the effort to improve the total pressure Pt measurement by reducing the dimensions or the number of drain holes, the greater the risk of build-up of water or of particles. With a Pitot tube, there therefore has to be a trade-off between quality of the total pressure Pt measurement and risk of disturbing the measurement because of the penetration of water, and of particles conveyed by the flow of air where the measurement is performed.

In the operational life of aircraft, the drain holes can be polluted, because of the ingestion of dust, insects, plant residues or other foreign bodies. Because of their size and the position of the Pitot tubes on the fuselage of an aircraft, the periodic checking of the integrity of the drain holes is difficult.

The checking of the drain holes of the Pitot tubes is generally done visually. The operator responsible for aircraft maintenance inspects the drain hole or holes using a small lamp. If foreign bodies are observed, the probe is dismantled, and its pneumatic circuits cleaned. This operation is all the more difficult when the aircraft is of large size. The access to the probe and to the drain holes whose diameter is generally less than 1 mm is difficult.

Also known from the applicant is a checking device intended to be connected temporarily to the pressure measurement probe, and that makes it possible to check, using an acoustic transmitter and an acoustic receiver, the non-blocking of the internal cavities and of the drain holes of the probe. The principle of such a device is notably described by the patent published under the reference FR 2 959 822. It is also recalled by FIG. 2 of this application. The checking device 25 comprises a transmitter 26 and a receiver 27 that are intended to be connected to an internal volume 30 of the probe, formed by the inside of the tube 14, the drain hole or holes 23 and the line 24. The transmitter transmits an acoustic signal that is propagated in the internal volume 30 and the receiver is configured to pick up an acoustic signal observed in the internal volume 30. The device also comprises means 28 for comparing the acoustic signal observed in the internal volume to a reference acoustic signal, in order to establish the presence of particles in the internal volume.

However, this checking device has the drawback of directly connecting the acoustic receiver with the internal volume of the pressure measurement probe. The acoustic receiver is therefore exposed to the liquids or particles likely to be present in the probe. The result thereof is a risk of pollution of the acoustic receiver, that can disturb the effectiveness of the checking device.

### SUMMARY OF THE INVENTION

The present invention aims to mitigate this drawback by proposing an optimized checking device intended to be connected temporarily to a pressure measurement probe.

To this end, the subject of the invention is a checking device in which the acoustic receiver is positioned behind the membrane of the loudspeaker transmitting the acoustic signal into the internal volume of the probe. More specifically, the invention relates to a device for checking a probe for measuring the pressure of a flow, the probe comprising:
an internal volume,
at least one orifice communicating with the outside of the volume,
an acoustic loudspeaker, comprising an enclosure and a membrane sealing an opening of the enclosure; the opening being intended to be connected to the internal volume of the probe, in such a way that the loudspeaker transmits an acoustic signal that is propagated through the opening into the internal volume,
an acoustic receiver positioned in the enclosure of the loudspeaker that makes it possible to pick up an acoustic signal originating from the outside of the enclosure and passing through the membrane,
and means for comparing the acoustic signal observed in the enclosure to a reference acoustic signal.

Advantageously, the loudspeaker comprises sealing means opposing the ingress, into the enclosure through the opening, of liquid or particles present in the internal volume of the probe.

Advantageously, the enclosure comprises a vent that makes it possible to maintain the interior of the enclosure at atmospheric pressure.

Advantageously, the device comprises information means if a deviation between the acoustic signal picked up and the reference signal exceeds a predefined threshold.

Advantageously, the transmitted acoustic signal sweeps a given frequency band and the acoustic signal picked up is compared over the frequency band to a reference spectrum.

Advantageously, the device is intended to perform the checking of a total pressure, static pressure, Pitot/static probe or a probe of totally or partially pneumatic incidence.

Advantageously, the membrane is intended to be connected to the internal volume in the vicinity of an inlet orifice for a stream of air from the flow into the probe.

### BRIEF DESCRIPTION OF THE DRAWINGS

The invention will be better understood and other advantages will become apparent on reading the detailed description of the embodiments given by way of example in the following figures:

FIG. 1, already presented, represents a total pressure measurement probe according to the prior known art,

FIG. 2, already presented, represents a partial view of the probe of FIG. 1 in the vicinity of which is positioned a checking device according to the prior known art,

FIG. 3 represents a checking device according to the invention,

FIG. 4 represents a partial view of the probe of FIG. 1 in the vicinity of which is positioned a checking device according to the invention.

In the interests of clarity, the same elements bear the same references in the different figures.

### DETAILED DESCRIPTION

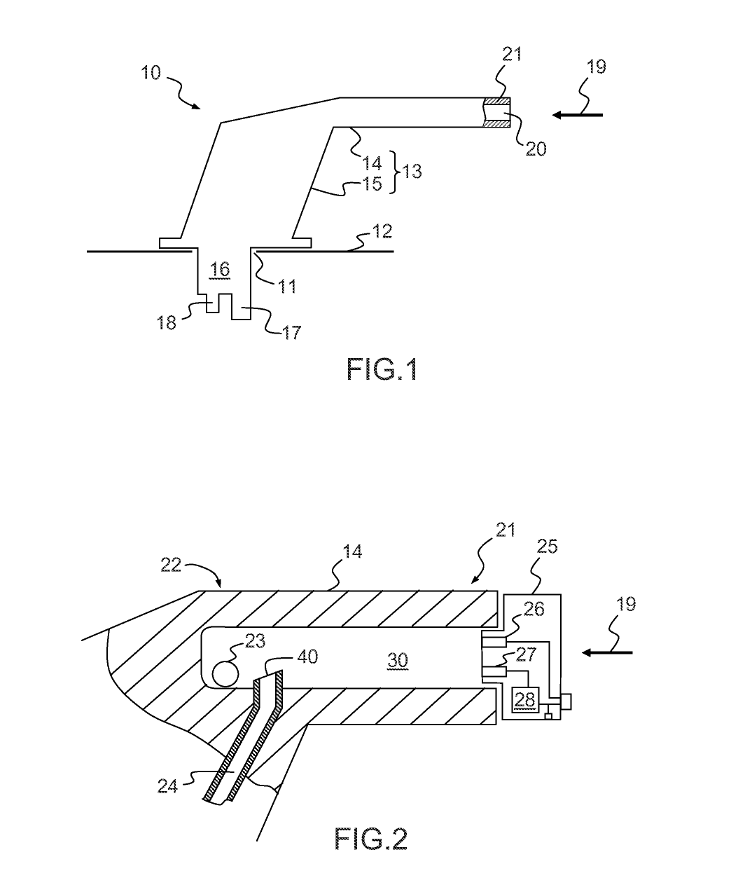

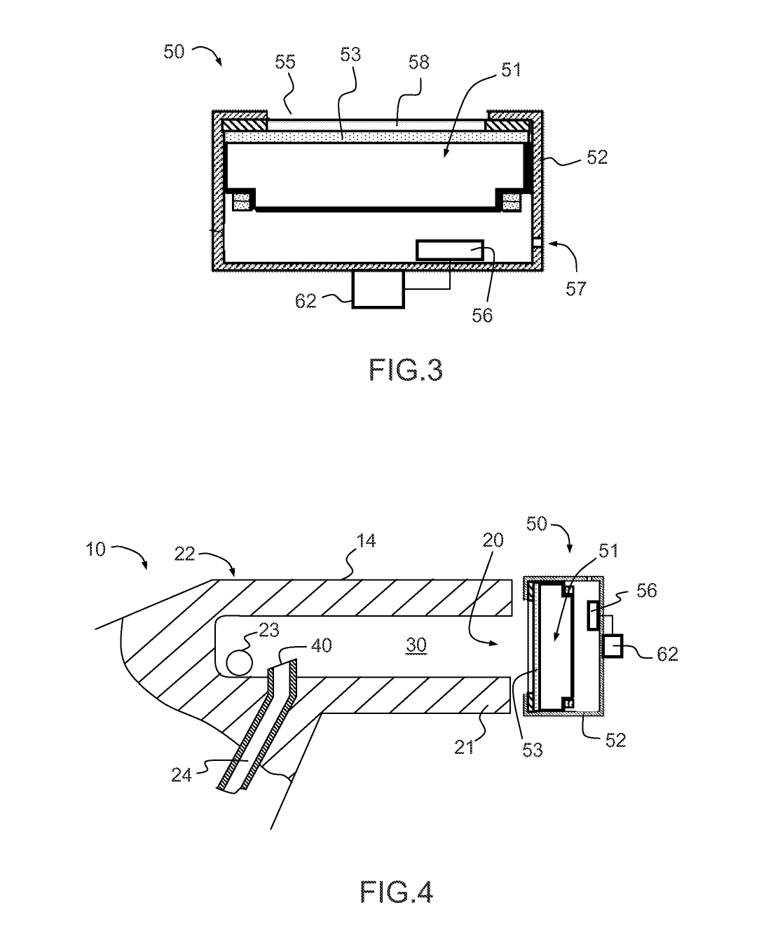

FIG. 3 represents a checking device according to the invention intended to be connected temporarily to a probe for measuring the pressure of a flow, during an aircraft maintenance operation. The invention is described in relation to a total pressure measurement probe, similar to that described previously by FIG. 1. It is of course possible to implement it for a static pressure measurement probe, for a Pitot/static probe or for a probe of totally or partially pneumatic incidence. Generally, the device according to the invention is intended for the checking of a probe comprising an internal volume and at least one orifice communicating with the outside of the volume. In the case of the total pressure probe previously described, the internal volume 30 of the probe comprises the inside of the Pitot tube 14, the drain hole or holes 23 and the line 24 for example linked to a pressure sensor. In a widely-used architecture, the probe comprises two drain holes formed facing one another in the Pitot tube.

As represented in FIG. 3, the checking device 50 comprises an acoustic loudspeaker 51 comprising an enclosure 52 and a membrane 53. The acoustic loudspeaker is an electromechanical transducer capable of producing an acoustic signal from an electrical signal. As is known, the loudspeaker comprises a motor (not represented) converting electrical energy into mechanical energy transmitted to the membrane 53 which produces the acoustic signal by transmitting this mechanical energy to the ambient air. The membrane 53 is positioned in the enclosure, sealing an opening 55 of the enclosure 52. The membrane 53 seals the opening by occupying the entire surface area thereof. Thus, the loudspeaker is configured to transmit an acoustic signal which is propagated out of the enclosure through the opening. The acoustic signal is also propagated inside the enclosure, in an internal cavity 60.

The enclosure 52 can also comprise a vent 57 communicating with the outside of the enclosure to make it possible to balance the pressure variations in the internal cavity 60. In other words, the vent makes it possible to maintain the interior of the enclosure at atmospheric pressure.

The loudspeaker can also comprise sealing means 58 opposing the ingress into the enclosure 52 through the opening 55 of liquid or particles present in the internal volume of the probe. Obviously, the sealing means 58 remain permeable to any acoustic signal.

The checking device 50 also comprises an acoustic receiver 56 placed in the enclosure 52 of the loudspeaker 51. The receiver makes it possible to pick up an acoustic signal observed in the internal cavity 60 of the enclosure 52. The receiver is not in direct contact with the outside of the enclosure of the loudspeaker 51.

FIG. 4 represents the checking device connected to a pressure measurement probe. The pressure measurement probe, represented partially in FIG. 4, notably comprises the Pitot tube 14 described previously. The device is connected to the open end 21 of the probe, in such a way that the membrane 53 of the loudspeaker is positioned facing the inlet orifice 20 of the Pitot tube. In other words, the opening 55 of the enclosure 52 is intended to be connected to the internal volume 30 of the probe, so that the loudspeaker transmits an acoustic signal that is propagated through the opening 55 into the internal volume. For the connection to the probe, the provision of removable fixing means on the enclosure, in proximity to the opening 55, intended to temporarily hold the device against the open end 21 of the probe, is envisaged.

The geometric form of the internal volume and the various connections of this volume with the other parts of the pneumatic circuit affect the acoustic signal observed in the internal volume of the probe. An acoustic signal transmitted by the loudspeaker 51 is propagated into the internal volume and is reflected thereby. The reflected acoustic signal is propagated in the internal volume to the membrane. It affects the acoustic signal observed in the internal cavity of the loudspeaker. In other words, the loudspeaker, which constitutes an acoustic speed generator, creates an acoustic wave affected by the internal volume. The acoustic impedance, defined as the ratio of the pressure to the speed of air particles, measured in proximity to the loudspeaker, is therefore affected by the geometry of the system. To put it yet another way, the acoustic impedance observed in the internal cavity of the loudspeaker (in proximity thereto) connected to the probe is an image of the acoustic impedance observed in the internal volume of the probe.

The acoustic signal observed in the enclosure therefore depends on any particles located in the internal volume and, notably, when the drain hole 23 is blocked. It is possible to define a reference signal that the receiver 56 receives when the internal volume is free of any particles. The checking device also comprises means 62 for comparing the reference signal with the acoustic signal observed in the enclosure when analysing the probe during testing. This reference signal can be defined on a new probe 10 or after an exhaustive visual check of a probe 10. If the device is used on a probe 10 mounted on an aircraft, the reference signal can depend on the aircraft itself and in particular on the part of the pneumatic circuit not belonging to the probe 10.

A deviation between the observed signal and the reference signal makes it possible to establish the presence of particles in the internal volume. In case of detection of the particles, a maintenance operation on the probe 10 is necessary to remove the particles that are present. On the other hand, if the deviation is not significant, the probe 10 is considered to be operational. Carrying out such a check is very quick to implement. This check can be performed directly on the aircraft without dismantling the probe 10. This check can also be performed during a maintenance operation on the probe 10 in order to check that the particles, notably any that might block the drain hole 23, have indeed been removed.

Advantageously, the checking device 50 comprises information means if a deviation between the observed signal and the reference signal exceeds a predefined threshold. The predefined threshold can be stored in a memory of the checking device. The threshold can be defined using tests by testing the sizes of different particles inserted into the internal volume, at different locations thereof. The information means can be formed by a lamp that an operator can observe during a checking operation. The information means can also be connected remotely by means of a connector of the device.

During a checking operation by means of the device 25, it is possible, for example, to search for a resonance frequency of the internal volume. This frequency is a function of any blocking of the drain hole 23 or of particles present in the internal volume. Advantageously, the acoustic signal transmitted by the transmitter can be the acoustic signal obtained by sweeping a given frequency band. The acoustic signal observed by the receiver is compared over the frequency band to a reference spectrum. The frequency band can cover extended acoustic frequencies suited to the type of probe and more generally to the complete pneumatic circuit.

The configuration of the device incorporating the receiver in the enclosure of the loudspeaker is particularly advantageous because it makes it possible to protect the receiver from any ingress of liquid or particles present in the probe. By implementing sealing means opposing the ingress through the opening, and by forming a vent of small size and positioned away from the connection with the probe, the device is effectively protected from the risks of pollution of the acoustic receiver by the probe.

1. A device for checking a probe for measuring the pressure of a flow, the probe comprising:
an internal volume,
at least one orifice communicating with the outside of the volume,
an acoustic loudspeaker, comprising an enclosure and a membrane sealing an opening of the enclosure; the opening being intended to be connected to the internal volume of the probe, so that the loudspeaker transmits an acoustic signal that is propagated through the opening into the internal volume,
an acoustic receiver positioned in the enclosure of the loudspeaker that makes it possible to pick up an acoustic signal originating from outside the enclosure and passing through the membrane, and
means for comparing the acoustic signal observed in the enclosure to a reference acoustic signal.

2. The device according to claim 1, in which the loudspeaker comprises sealing means opposing the ingress, into the enclosure through the opening, of liquid or of particles present in the internal volume of the probe.

3. The device according to claim 1, wherein the enclosure comprises a vent that makes it possible to maintain the interior of the enclosure at atmospheric pressure.

4. The device according to claim 1, further comprising information means if a deviation between the acoustic signal picked up and the reference signal exceeds a predefined threshold.

5. The device according to claim 1, wherein the acoustic signal transmitted sweeps a given frequency band and in which the acoustic signal picked up is compared over the frequency band to a reference spectrum.

6. The device according to claim 1, wherein the device is intended to perform the checking of a total pressure, static pressure, Pitot/static probe or a probe of totally or partially pneumatic incidence.

7. The device according to claim 1, wherein the membrane is intended to be connected to the internal volume in the vicinity of an inlet orifice for a stream of air from the flow into the probe.
